(19) United States
(12) Patent Application Publication
(10) Pub. No.: US 2025/0209936 A1
(43) Pub. Date: Jun. 26, 2025

(54) METHOD AND SYSTEM OF SYMBOL SELECTION FOR THE VISUALLY IMPAIRED

(71) Applicant: Victorialand Beauty, LLC, Naples, FL (US)

(72) Inventor: Victoria Watts, Ponte Vedra Beach, FL (US)

(73) Assignee: Victorialand Beauty, LLC, Naples, FL (US)

(21) Appl. No.: 18/988,908

(22) Filed: Dec. 20, 2024

Related U.S. Application Data
(60) Provisional application No. 63/614,851, filed on Dec. 26, 2023.

(51) Int. Cl. G09B 21/00; G06K 7/10; G06K 7/14; G06K 19/06; G09F 3/00; G09F 3/02; G09F 3/10

(52) U.S. Cl. CPC G09B 21/007; G06K 7/1417; G06K 19/06037; G06K 19/06159; G09F 3/0297; G09F 3/10; G06K 2007/10504; G09F 2003/0208; G09F 2003/0226; G09F 2003/0257; G09F 2003/0273

(57) ABSTRACT

A method and system of product identification by symbol selection for the visually impaired and a substrate for use in connection with the system and method. The substrate consists of a side with a number of raised adhesive symbols surrounded by raised locator markings to help locate the raised adhesive symbols. Aural instructions are obtained by engaging a QR code reader with a raised substrate QR code on the substrate. These instructions tell the user how to navigate the substrate. A user can then peel the desired adhesive symbol off of the substrate and apply it to a relevant object so that the user can then identify the object through tactile means alone. Additional symbol QR codes located in close proximity to the symbol portion of each adhesive symbol provide instant access to audible product information corresponding to the object associated with the adhesive symbol.

### FIELD OF THE INVENTION

The present invention relates generally to a method and system of product identification by tactile symbol selection for the visually impaired.

### BACKGROUND OF THE INVENTION

Visually impaired individuals face a number of challenges in the sighted world. One of these challenges relates to product identification. Visually impaired individuals, like all individuals purchase numerous packaged goods for use. Most products are packaged in generic or stock packaging which all look and feel alike. As a result, visually impaired individuals are unable to readily identify the similarly packaged, and in many cases, different, products.

For example, a visually impaired individual that has purchased both shampoo and conditioner may be unable to distinguish between the two products if they have identical packaging.

The braille language system, a tactile code that enables reading by touch, has been used to identify products, but braille is relatively difficult to learn and is used by only ten percent of the visually impaired individuals in the United States. Some companies have placed raised markings on their packaging in order to help visually impaired individuals identify the products. For example, the Kao Soap Company of Japan pioneered the use of tactile markings on shampoo and conditioner bottles in 1991. In the United States, Procter & Gamble has included tactile markings on its Herbal Essences shampoo and conditioner products in order distinguish between the two products.

However, to date, no system has been developed that permits a visually impaired individual to provide tactile symbols on products to enable the individual to readily identify a product package and specific information describing the product without the aid of any other person or need to understand a difficult to learn tactile code, such as braille.

### SUMMARY OF THE INVENTION

A system for the selection of object symbols by the visually impaired is provided. In embodiments, the system comprises a substrate comprising a first side and a second side, the first side having a first layer and a second layer, and an upper portion and a lower portion, wherein the first layer comprises a flat surface. The second layer comprises (1) a raised orienting marking to identify the upper portion of the first side of the substrate, (2) a raised substrate QR code or other machine readable code (bar code or otherwise) that enables an audible description, oriented in relation to the orientation of the substrate and providing aural instructions for use of the substrate; and (3) a plurality of adhesive raised symbols corresponding to a plurality of specific objects with each of the plurality of adhesive raised symbols surrounded by a raised locator marking configured to enable selection of one of the plurality of symbols by tactile orientation alone.

The system includes a QR code reader configured to read the raised substrate QR code to enable a user of the substrate to receive aural instructions on the location of each symbol of the plurality of adhesive raised symbols on the substrate and to use the raised locator marking to locate, select and remove one of the plurality of adhesive raised symbols to apply to packaging identified as corresponding to one of the specific objects.

In embodiments, any other types of readable codes, such as a conventional bar code, or any other code that can be read by a code reader designed to read the code that enables an audible description, may be used.

In embodiments, each adhesive raised symbol relates to a real-world object, a specific good, or a specific consumer product. In embodiments, the specific good or consumer product, for example, relates to home care products, self-care products or skincare products. However, one of ordinary skill in the art will recognize that a variety of adhesive raised symbols can be developed and used in connection with any type of real-world object, specific good or specific consumer product in many diverse industries.

In embodiments, the first layer is removably attached to the second layer. Alternatively, the second layer is removably attached to the first layer.

In embodiments, the raised orienting indicia identify a top end of the substrate.

In embodiments, the raised substrate QR code is oriented in relation to the top end of the substrate.

In embodiments, a symbol QR code relating to and providing information about the specific object corresponding to at least one of the plurality of adhesive symbols is oriented on the first side of the substrate and incorporated as a QR code portion, immediately adjacent, or in close proximity to, the symbol portion of the adhesive symbol.

A substrate for the selection of object symbols by the visually impaired is disclosed. In embodiments, the substrate comprises a first side and a second side, with the first side containing a first layer and a second layer, and an upper portion and a lower portion. The first layer comprises a flat surface and the second layer comprises (1) a raised orienting marking to identify the upper portion of the first side of the substrate; (2) a raised substrate QR code oriented in relation to the orientation of the substrate and providing aural instructions for use of the substrate; and (3) a plurality of adhesive raised symbols corresponding to a plurality of specific objects with each of the plurality of adhesive raised symbols surrounded by a raised locator marking configured to enable selection of one of the plurality of symbols by tactile orientation alone.

In embodiments, the second layer of the substrate further includes a plurality of symbol QR codes that enable an audible description corresponding to each of the plurality of specific objects, wherein each of the plurality of symbol QR codes is oriented adjacent, or in close proximity to, the symbol portion of the adhesive raised symbols and on each of the corresponding adhesive raised symbols.

In embodiments the substrate can be made out of laminated cardstock. The substrate can also be made out of any other pliable material that permits the creation of raised portions.

A method for enabling the visually impaired to identify objects is disclosed. The first step comprises selecting a substrate comprising a first side and a second side, with the first side containing a first layer and a second layer, and an upper portion and a lower portion, and where the first layer comprises a flat surface and the second layer comprises (i) a raised orienting marking to identify the upper portion of the first side of the substrate; (ii) a raised substate QR code oriented in relation to the orientation of the substrate and providing aural instructions for use of the substrate; (iii) a plurality of adhesive raised symbols corresponding to a plurality of specific objects with each of the plurality of adhesive raised symbols surrounded by a raised locator marking configured to enable selection of a desired symbol by tactile orientation alone, with each of the plurality of adhesive symbols having a symbol QR code associated with that adhesive symbol incorporated within the locator marking and located adjacent, or in close proximity to, the symbol portion of the adhesive symbol.

The next steps of the method are (2) locating the raised substrate QR code by tactile orientation; (3) using a QR code reader to retrieve aural instructions associated with the raised substrate QR code on how to use the substrate; (4) locating the raised orienting marking to identify the top of the first layer of the substrate; (5) locating the raised locator marking configured to enable selection of a symbol by tactile orientation alone; (6) identifying at least one of the plurality of raised symbols; (7) selecting at least one of the plurality of raised symbols; (8) peeling the at least one of the plurality of raised symbols from the substrate; and (9) applying the raised symbol to a corresponding object package and identifying the corresponding object package by tactile recognition of the symbol. In embodiments where a symbol QR code is located on one or more of the plurality of adhesive raised symbols and adjacent or in close proximity to the symbol portion of one or more of the plurality of raised symbols, further audible product information can be obtained by using a QR code reader to read the symbol QR code. The integration of a symbol QR code with each of the plurality of raised symbols ensures an inclusive, accessible and seamless experience to access product information for all users including the visually impaired.

Employing this method enables users to locate a tactile symbol, guide the user to the readable code (i.e., a symbol QR code in embodiments), point the machine reader (i.e., the QR code reader in embodiments) at the readable code adjacent to the symbol so as to provide audible product details, such as name, ingredients and how to use as well as other related products.

These and other features of this invention are described in, or are apparent from, the following detailed description of various exemplary embodiments of this invention.

### BRIEF DESCRIPTION OF THE DRAWINGS

Exemplary embodiments of this invention will be described with reference to the accompanying figures wherein:

FIG. 1 illustrates first side of a substrate of the present invention.

FIG. 2 illustrates a user engaging a raised substrate QR code on the substrate of the present invention.

FIG. 3 illustrates an adhesive raised symbol removed from the substrate and being placed on packaging for an object in accordance with the present invention.

FIG. 4 illustrates a user engaging the adhesive raised symbol after it has been placed on the packaging for an object in accordance with the present invention.

FIG. 5 illustrates one of the plurality of adhesive raised symbols in an embodiment where a symbol QR code is located below the symbol portion of the adhesive raised symbol.

FIG. 6 illustrates a portion of an embodiment of the first side of the present invention where symbol QR codes are located on the adhesive raised symbols, adjacent and below the symbol portions of adhesive raised symbols, such as illustrated in FIG. 5.

FIG. 7 illustrates the entire first side of the embodiment of the present invention illustrated in FIG. 6.

### DETAILED DESCRIPTION OF THE EXEMPLARY EMBODIMENTS

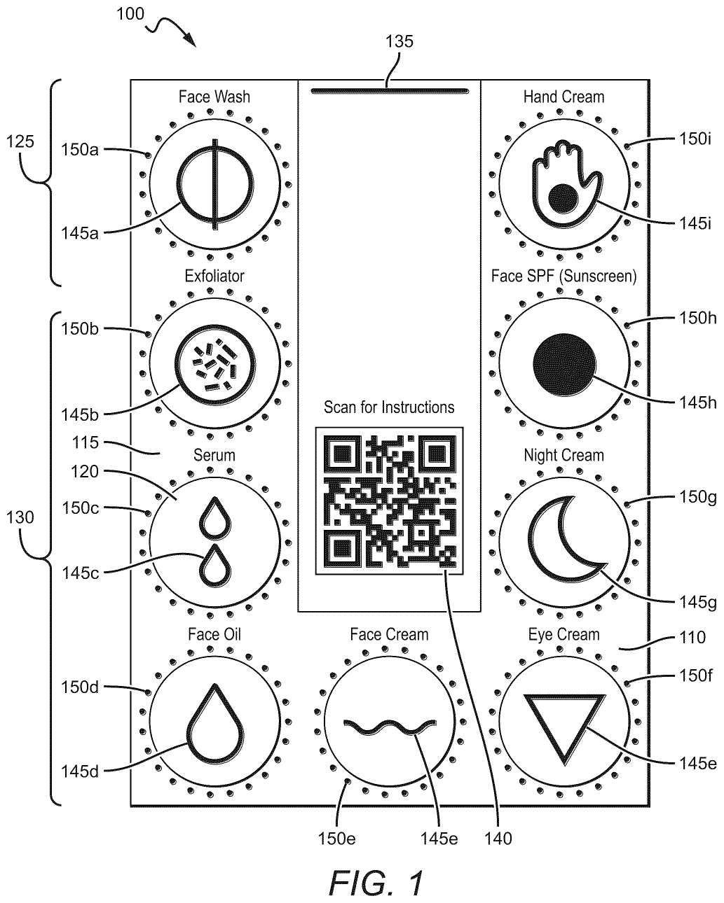

With reference to FIG. 1, the details of substrate 100 for the selection of object symbols by the visually impaired is illustrated. Substrate 100 comprises a first side 110 and a second side (the other side of the substrate, not shown). First side 110 contains a first layer 115 and a second layer 120, as well as upper portion 125 and lower portion 130. Second layer 120 is raised (i.e., at a higher elevation) than first layer 115. Second layer 120 comprises a raised orienting marking 135 to identify the upper portion of first side 110 of substrate 100. In the embodiment shown in FIG. 1, raised orienting marking 135 is shown as a horizontal line, but this marking can be of any shape so long as it is unique on substrate 100 allowing an individual through tactile feeling to distinguish upper portion 125 of substrate 100 from lower portion 130.

Raised substrate QR code 140 is oriented in relation to the orientation of substrate 100 (i.e., it aligns in the same orientation as substrate 100). Raised substrate QR code 140 is raised so that a user can determine its location through tactile means only. Once that location has been identified, a user can scan raised substrate QR code 140 with a QR code reader (not shown) to receive aural instructions as to the use of substrate 100.

Substrate 100 has a plurality of adhesive raised symbols. In the embodiment shown in FIG. 1, there are nine adhesive raised symbols 145a-145i, with each adhesive raised symbol surrounded by a raised locator marking 150a-150i. The raised locator markings permit a user with tactile sense alone, to determine the location of the adhesive raised symbols.

In the embodiment shown in FIG. 1, the adhesive raised symbols all pertain to skin care products. Each raised symbol is a different configuration to permit a user to differentiate between them using tactile touch alone. Instructions about these symbols are relayed aurally by an audio file accessed by scanning the raised substrate QR code 140 through the use of a QR code reader (not shown). For example, adhesive symbol 145b corresponds to “exfoliator”, a skin care product. In embodiments, the adhesive symbols all relate to a certain genre of products. In embodiments, there is no specific relation between the types of products contained on substrate 100. For example, the adhesive symbols could simply relate to various household items a user may encounter. In embodiments, the product (i.e., object) can be a real-world object, a specific good or a specific consumer product, or any other type of object so long as it has a smooth surface upon which to place an adhesive symbol so that the product could be identified using tactile means.

In embodiments, first layer 115 is removably attached to second layer 120. Alternatively, the second layer is removably attached to the first layer. In embodiments, and as shown in FIG. 1, the raised orienting indicia 135 identifies both the upper portion of the substrate as well as the top end of the substrate. In embodiments, the raised substrate QR code 140 is oriented in relation to the top end of the substrate.

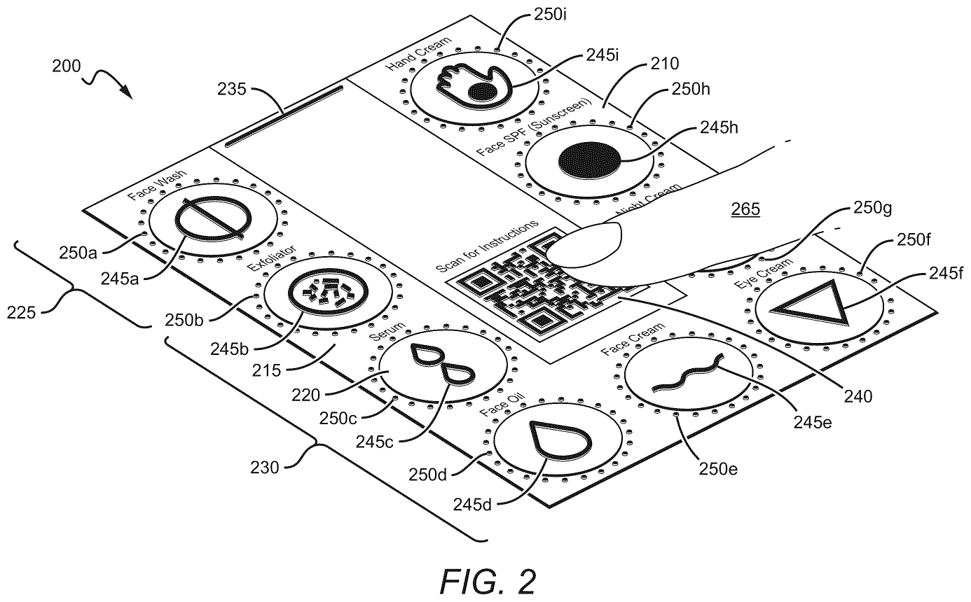

FIG. 2 illustrates a user engaging with substrate 200 in accordance with the present invention using finger 265 to identify the location of raised substrate QR code 240. In accordance with the system for the selection of object symbols by the visually impaired as well as a method for enabling the visually impaired to identify objects, once the user has located the raised substrate QR code 240 by tactile orientation, the user uses a QR code reader (not shown) to retrieve aural instructions associated with raised substrate QR code 240 on how to use substrate 200. The user then would locate the raised orienting marking 235 to identify the top portion 225 of first layer 215 of substrate 200. The user then would locate one of the plurality of raised locator markings 250a-250i in order to identify one of a plurality of raised symbols 245a-245i (raised symbol 245g is not shown on FIG. 2).

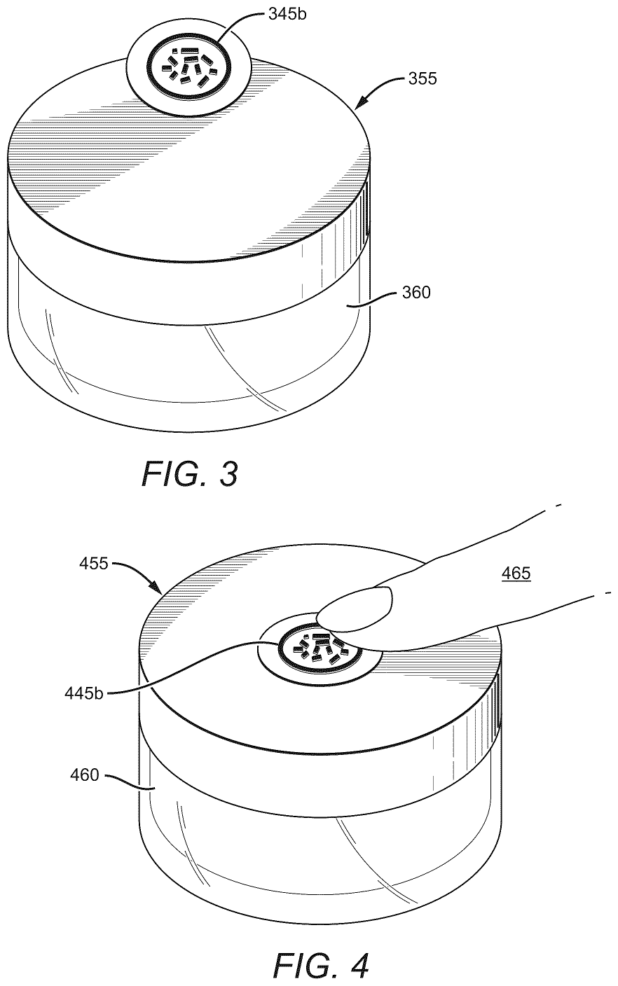

In the example illustrated in the figures, the user has selected raised symbol 245b which corresponds to “exfoliator”. As part of the system and method of the present invention, the user peels off (i.e., selects and removes) at least one of the plurality of adhesive raised symbols (in this case, that for exfoliator, corresponding to 245b) from second layer 120 at first side 110 of substrate 100 and then applies the raised symbol to a corresponding object package. In FIG. 3, the application of raised symbol 345b (corresponding to “exfoliator”) is shown being applied to object package 355, which in this embodiment would correspond to exfoliator. In embodiments, the packaging could be a carton packaging surrounding the product itself. In a preferred embodiment, the packaging that receives the raised symbol is the object package 355 into which the product 360 (i.e., the exfoliator in the present example) is placed.

FIG. 4 illustrates a user engaging the adhesive raised symbol through tactile engagement in connection with embodiments of the present invention. As seen in FIG. 4, the user, using finger 465 touches object package 455, identifying raised symbol 445b on the top of object package 455. The user would feel raised symbol 445b, and in accordance with the example illustrated in FIGS. 1-4, would recognize that this product is “exfoliator”.

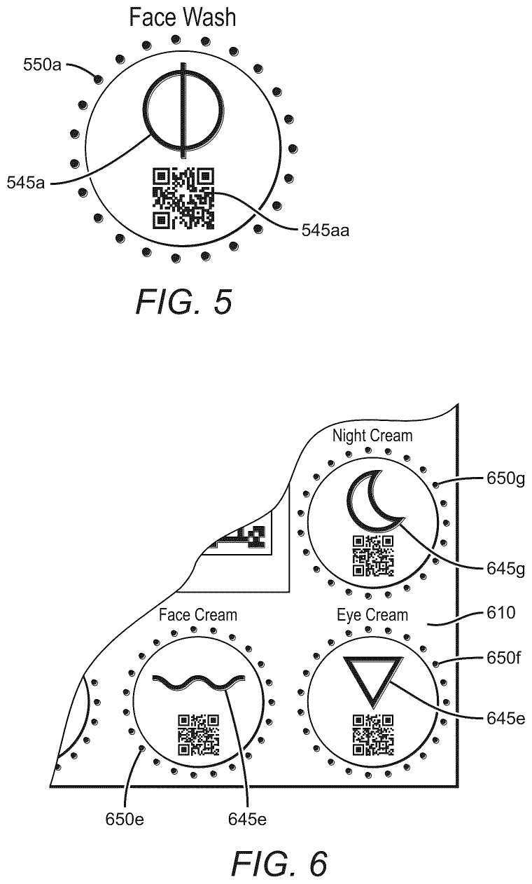

FIG. 5 illustrates one of the plurality of adhesive raised symbols in an embodiment where a symbol QR code is located adjacent, in close proximity to, and specifically below, the symbol portion of the adhesive raised symbol and within the raised locator markings. In embodiments the symbol QR code may be located in close proximity, but not necessarily below, the symbol portion of the adhesive raised symbol. As shown in FIG. 5, symbol QR code 545aa is located below symbol portion of the adhesive symbol 545a, and within raised locator markings 550a. By including symbol QR code 545aa within raised locator marking 550a and below the symbol portion of adhesive symbol 545a, a user can instantly gain access to audible product information by using a QR code reader to scan the QR code and retrieve the aural information associated with the adhesive symbol.

In embodiments, each of the nine adhesive symbols 145a-145i shown in FIG. 1 has a corresponding symbol QR code (i.e., a first symbol QR code, second symbol QR code, third symbol QR code, etc.), such as shown with respect to adhesive symbol 545a in FIG. 5, with corresponding symbol QR code 545aa. In the embodiment shown in FIG. 5, corresponding symbol QR code 545aa is located within raised locator markings 550a. However, in embodiments (not shown), corresponding QR code 545aa is located outside of raised locator markings 550a.

FIG. 6 illustrates a portion of an embodiment of the first side of the present invention where the symbol QR code is located below the symbol portion of the adhesive raised symbols and within the raised locator markings, such as illustrated in FIG. 5. As seen in FIG. 6, raised locator markings 650e, 650f, 650g, each encircle the respective adhesive raised symbols 645e, 645f, 645g. Each of these adhesive raised symbols includes a symbol portion and a corresponding symbol QR code (i.e., symbol QR codes 645ee, 645ff and 645gg) that can be read with a QR code reader to provide audible information about the product to which the symbol portion of the adhesive raised symbol corresponds. In embodiments, each symbol portion of the adhesive raised symbol on first side 610 has a corresponding symbol QR code. In embodiments, only one or more of the symbol portions of the adhesive raised symbols has a corresponding symbol QR code. In embodiments, one or more of the corresponding symbol QR codes are raised so that they can be identified by a visually impaired individual. In embodiments, only the symbol portions of the adhesive raised symbols are raised.

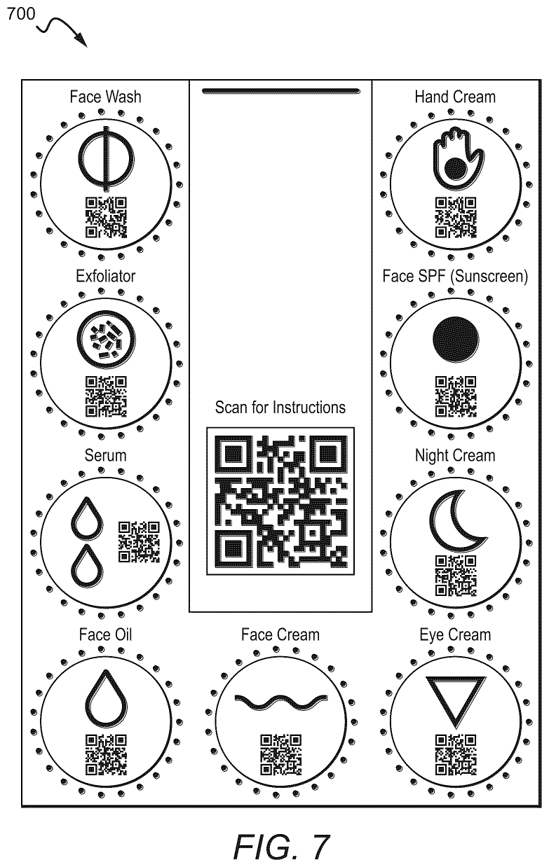

FIG. 7 illustrates the entire first side of an embodiment where each of the adhesive raised symbols of substrate 700 has a corresponding symbol QR code that can be read with a QR code reader to provide audible information about the product to which the symbol portion of the adhesive raised symbol corresponds.

Now that embodiments of the present invention have been shown and described in detail, various modifications and improvements thereon will become readily apparent to those skilled in the art. Accordingly, the exemplary embodiments of the invention, as set forth above, are intended to be illustrative, not limiting. The spirit and scope of the present invention is to be construed broadly.

1. A system for product identification and the selection of object symbols by the visually impaired, the system comprising:
a substrate comprising:
a first side and a second side, the first side having a first layer and a second layer, and an upper portion and a lower portion, wherein
the first layer comprises a flat surface;
the second layer comprises:
a raised orienting marking to identify the upper portion of the first side of the substrate,
a raised substrate QR code oriented in relation to the orientation of the substrate and providing aural instructions for use of the substrate;
a plurality of adhesive raised symbols with a symbol portion corresponding to a plurality of specific objects with each of the plurality of adhesive raised symbols surrounded by a raised locator marking configured to enable selection of one of the plurality of symbols by tactile orientation alone;
a QR code reader configured to read the raised substrate QR code to enable a user of the substrate to receive aural instructions on the location of each symbol of the plurality of adhesive raised symbols on the substrate and to use the raised locator marking to locate, select and remove one of the plurality of adhesive raised symbols to apply to packaging identified as corresponding to one of the specific objects.

2. The system of claim 1, wherein the first layer is removably attached to the second layer.

3. The system of claim 1, wherein the raised orienting indicia identify a top end of the substrate.

4. The system of claim 1, wherein the raised substrate QR code is oriented in relation to the top end of the substrate.

5. The system of claim 1, wherein a first symbol QR code relating to the specific object corresponding to at least one of the symbol portions of the plurality of adhesive raised symbols is oriented on the first side of the substrate in close proximity to at least one of the symbol portions of the adhesive raised symbols.

6. The system of claim 1, wherein the object comprises at least one of the following: a real-world object, a specific good, a specific consumer product.

7. A substrate for the selection of object symbols by the visually impaired, the substrate comprising:
a first side and a second side, the first side containing a first layer and a second layer, and an upper portion and a lower portion, wherein
the first layer comprises a flat surface;
the second layer comprises
a raised orienting marking to identify the upper portion of the first side of the substrate,
a raised substrate QR code oriented in relation to the orientation of the substrate and providing aural instructions for use of the substrate,
a plurality of adhesive raised symbols with symbol portions corresponding to a plurality of specific objects with each of the plurality of adhesive raised symbols surrounded by a raised locator marking configured to enable selection of one of the plurality of adhesive raised symbols by tactile orientation alone.

8. The substrate of claim 1 wherein the second layer further comprises a plurality of symbol QR codes corresponding to the plurality of specific objects, wherein each of the plurality of symbol QR codes is oriented adjacent each of the symbol portions of the corresponding adhesive raised symbols and within the raised locator marking.

9. A method for enabling the visually impaired to identify objects comprising the steps of:
selecting a substrate comprising:
a first side and a second side, the first side containing a first layer and a second layer, and an upper portion and a lower portion, wherein
the first layer comprises a flat surface;
the second layer comprises:
a raised orienting marking to identify the upper portion of the first side of the substrate,
a raised substrate QR code oriented in relation to the orientation of the substrate and providing aural instructions for use of the substrate,
a plurality of adhesive raised symbols with symbol portions corresponding to a plurality of specific objects with each of the plurality of adhesive raised symbols surrounded by a raised locator marking configured to enable selection of a desired symbol by tactile orientation alone and with a plurality of symbol QR codes corresponding to each of the plurality of symbol portions of the adhesive raised symbols located adjacent each of the symbol portions of the plurality of adhesive raised symbols;
locating the raised substrate QR code by tactile orientation;
using a QR code reader to retrieve aural instructions associated with the raised substrate QR code on how to use the substrate;
locating the raised orienting marking to identify the top of the first layer of the substrate;
locating the raised locator marking configured to enable selection of a raised adhesive symbol by tactile orientation alone;
identifying at least one of the plurality of raised adhesive symbols;
selecting at least one of the plurality of raised adhesive symbols;
using a QR code reader to retrieve aural instructions about the product associated with one or more of the symbol QR codes located adjacent one or more of the plurality of adhesive symbols;
peeling the at least one of the plurality of raised adhesive symbols from the substrate;
applying the raised adhesive symbol to a corresponding object package;
and identifying the corresponding object package by tactile recognition of the symbol and by using the QR code reader to read the symbol QR code associated with the raised symbol corresponding to the corresponding object package.
